(19) United States
(12) Patent Application Publication
(10) Pub. No.: US 2020/0335246 A1
(43) Pub. Date: Oct. 22, 2020

(54) Fe-Co BASED AMORPHOUS SOFT MAGNETIC ALLOY AND PREPARATION METHOD THEREOF

(71) Applicants: Baolong Shen, Nanjing (CN); Donghui Li, Nanjing (CN); Xingdu Fan, Nanjing (CN); Qianqian Wang, Nanjing (CN); Mufeng Jiang, Nanjingsu (CN); Xiangrong Jiang, Nanjing (CN); Xiangyue Wang, Nanjing, Jiangsu (CN)

(72) Inventors: Baolong Shen, Nanjing (CN); Donghui Li, Nanjing (CN); Xingdu Fan, Nanjing (CN); Qianqian Wang, Nanjing (CN); Mufeng Jiang, Nanjingsu (CN); Xiangrong Jiang, Nanjing (CN); Xiangyue Wang, Nanjing, Jiangsu (CN)

(21) Appl. No.: 16/851,117

(22) Filed: Apr. 17, 2020

(30) Foreign Application Priority Data
Apr. 19, 2019 (CN) 201910317627.2

(51) Int. Cl. H01F 1/153; C21D 9/52; C21D 8/02; C22C 45/02; C22C 33/06

(52) U.S. Cl. CPC H01F 1/15316; C21D 9/52; C21D 8/0205; C21D 8/0236; C22C 2202/02; C22C 45/02; C22C 33/06; H01F 1/15341; C21D 2201/03; C21D 8/0247

(57) ABSTRACT

The invention relates to the technical field of amorphous soft magnetic material, specifically relating to the field of Fe—Co based amorphous soft magnetic alloy and preparation method thereof. The Fe—Co based amorphous soft magnetic alloy provided in the invention has chemical composition of FeₐCo_{b}Si_{c}B_{d}Cuₑ, which possesses merits of highly-saturated magnetic induction, outstanding soft magnetic property and great amorphous forming ability at the same time; the embodiment of Fe—Co based amorphous soft magnetic alloy disclosed in the invention has indicated that its saturation magnetic induction is 1.79˜1.86 T, coercivity 1.4˜4.3 A/m, and permeability 8000˜14000; the invention has advantages of easy treatment process, low annealing temperature, which reduces process cost remarkably and economizes energy, thus having great application prospect.

### BACKGROUND OF THE INVENTION

### 1. Field of the Invention

The invention relates to the technical field of amorphous soft magnetic material, specifically relating to the field of Fe—Co based amorphous soft magnetic alloy and preparation method thereof.

### 2. Description of the Related Art

Soft magnetic material, an important component of magnetism material, has widespread use in electric power, motor, electron and other industrial fields. So far, soft magnetic materials widely used in engineering can be divided into metal soft magnetic material (such as silicon steel and permalloy), soft ferrite, amorphous and nanocrystalline soft magnetic materials.

Amorphous alloys are obtained via liquid quenching or physical and chemical deposition method. Unlike crystalline alloy, amorphous alloys skipped crystalization process like nucleation and growth and avoided atomic rearrangement in large scale, so it has structures completely different with traditional crystalline materials. The amorphous alloy has a macroscopically disordered structure and an atomic random arrangement, the unique structure of which enables it to show a plurality of excellent properties such as excellent soft magnetic properties, high strength, wear resistance and the like. Since 1980s, amorphous materials, as important soft magnetic materials, have gradually become the focus of research, development and application in the material science community at home and abroad .

Among them, Fe-based amorphous alloys are drawing much attention due to their advantages of low loss, high saturation magnetic induction and good amorphous forming ability, and are expected to be used as substitutes for silicon steel and ferrite, thus being widely applied to various electric and electronic devices. Researchers develop the Fe-based amorphous nanocrystalline alloy on the basis of the Fe-based amorphous alloy, providing a wider selection space for miniaturization, high efficiency and precision of electronic products.

At present, there are some reports about Fe-based amorphous or Fe-based nanocrystalline materials. It's still the target pursued by researchers to develop Fe-based amorphous or Fe-based nanocrystalline alloy with high saturation magnetic induction and low coercivity and simple preparation process.

### SUMMARY OF THE INVENTION

The invention aims to provide a Fe—Co based amorphous soft magnetic alloy and preparation method thereof which possesses highly-saturated magnetic induction, great amorphous forming ability, and low coercivity.

To achieve said invention purposes, the invention adopts following technical plans:

The invention provides a Fe—Co based amorphous soft magnetic alloy with a chemical composition of FeₐCo_{b}Si_{c}B_{d}Cuₑ wherein a, b, c, d, and e respectively represent the atomic percentage of corresponding components; a=60˜85, b=1˜20, c=0˜4, d=12˜16, e=0.5˜1.5, a+b +c+d+e=100.

Preferably, a+b=82˜83, c=0˜2, d=12˜14, e=1˜1.5, a+b+c+d+e=100.

Preferably, said Fe—Co amorphous soft magnetic alloy includes Fe_{78.65}Co₄Si₂B₁₄Cu_{1.35}, Fe_{74.65}Co₈Si₂B₁₄Cu_{1.35}, Fe_{70.65}Co₁₂Si₂B₁₄Cu_{1.35}, Fe_{66.65}Co₁₆Si₂B₁₄Cu_{1.35} and Fe_{62.65}Co₂₀Si₂B₁₄Cu_{1.35}.

The invention provides the preparation method of said Fe—Co based amorphous soft magnetic alloy in the above technical plan comprising following steps:

Mixing raw materials of Fe, Co, Si, B and Cu according to the atomic percentage to obtain a mixture;

smelting said mixture to obtain a master alloy ingot;

preparing the master alloy ingot into an amorphous alloy ribbon via single roll cold method;

annealing said amorphous alloy ribbon to obtain the Fe—Co based amorphous soft magnetic alloy.

Preferably, said Fe, Co, Si, B and Cu raw materials have a purity of >99%.

Preferably, the injection pressure of said single roll cold method is 0.01-0.03 MPa, the injection temperature is 1000-1050° C., and the linear velocity of the surface of the copper roll is 30-50 m/s.

Preferably, the width of said amorphous alloy ribbon is 1-1.5 mm, and the thickness thereof is 20-30 μm.

Preferably, the annealing treatment is carried out in a vacuum atmosphere or an inert atmosphere, and the vacuum degree of the vacuum atmosphere is (5˜8)×10⁻³ Pa.

Preferably, said annealing process is carried out under the action of an external magnetic field; the magnetic field strength of said external magnetic field is 200-1500 Oe.

Preferably, said annealing temperature is 290-370° C., and the annealing time is 5-30 min.

The invention provides a Fe—Co based amorphous soft magnetic alloy with a chemical composition of FeₐCo_{b}Si_{c}B_{d}Cuₑ wherein a, b, c, d, and e respectively represent the atomic percentage of corresponding components; a=60˜85, b=1˜20, c=0˜4, d=12˜16, e=0.5˜1.5, a+b +c+d+e=100. The Fe—Co based amorphous soft magnetic alloy of the invention has highly-saturated magnetic induction, outstanding soft magnetic property and great amorphous forming ability at the same time; the embodiment of Fe—Co based amorphous soft magnetic alloy disclosed in the invention has indicated that its saturation magnetic induction is 1.79˜1.86 T, coercivity 1.4˜4.3 A/m, and permeability 8000˜14000.

The invention has advantages of easy treatment process, low annealing temperature, which reduces process cost remarkably and economizes energy, thus having great application prospect.

### BRIEF DESCRIPTION OF THE DRAWINGS

FIG. 1 is the XRD diffraction diagram illustrating the Fe_{66.65}Co₁₆Si₂B₁₄Cu_{1.35} amorphous alloy ribbon of the embodiment 1 in the invention;

FIG. 2 is the DSC curve illustrating the Fe_{66.65}Co₁₆Si₂B₁₄Cu_{1.35} amorphous alloy ribbon of the embodiment 1 in the invention;

FIG. 3 is the XRD diffraction diagram illustrating the sample of Fe_{66.65}Co₁₆Si₂B₁₄Cu_{1.35} amorphous alloy ribbon after annealing in 370° C. of the embodiment 1 in the invention;

FIG. 4 is the hysteresis loop illustrating the sample of Fe_{66.65}Co₁₆Si₂B₁₄Cu_{1.35} amorphous alloy ribbon after annealing in 370° C. of the embodiment 1 in the invention;

FIG. 5 is curves illustrating changes of coercivity and permeability of Fe_{66.65}Co₁₆Si₂B₁₄Cu_{1.35} amorphous alloy ribbon after common stress-relief annealing and stress-relief annealing in magnetic field in different temperatures of the embodiment 1 in the invention;

FIG. 6 is the XRD diffraction diagram illustrating the Fe_{62.65}Co₂₀Si₂B₁₄Cu_{1.35} amorphous alloy ribbon of the embodiment 2 in the invention;

FIG. 7 is the DSC curve illustrating the Fe_{62.65}Co₂₀Si₂B₁₄Cu_{1.35} amorphous alloy ribbon of the embodiment 2 in the invention;

FIG. 8 is the XRD diffraction diagram illustrating the sample of Fe_{62.65}Co₂₀Si₂B₁₄Cu_{1.35} amorphous alloy ribbon after annealing in 370° C. of the embodiment 2 in the invention;

FIG. 9 is the hysteresis loop illustrating the sample of Fe_{62.65}Co₂₀Si₂B₁₄Cu_{1.35} amorphous alloy ribbon after annealing in 370° C. of the embodiment 2 in the invention;

FIG. 10 is curves illustrating changes of coercivity and permeability of Fe_{62.65}Co₂₀Si₂B₁₄Cu_{1.35} amorphous alloy ribbon after common stress-relief annealing and stress-relief annealing in magnetic field in different temperatures of the embodiment 2 in the invention;

FIG. 11 is the XRD diffraction diagram illustrating the Fe_{82.65}Si₂B₁₄Cu_{1.35} amorphous alloy ribbon of the comparative example 1 in the invention;

FIG. 12 is the DSC curve illustrating the Fe_{82.65}Si₂B₁₄Cu_{1.35} amorphous alloy ribbon of the comparative example 1 in the invention;

FIG. 13 is the XRD diffraction diagram illustrating the sample of Fe_{82.65}Si₂B₁₄Cu_{1.35} amorphous alloy ribbon after annealing in 350° C. of the comparative example 1 in the invention;

FIG. 14 is the hysteresis loop illustrating the sample of Fe_{82.65}Si₂B₁₄Cu_{1.35} amorphous alloy ribbon after annealing in 350° C. of the comparative example 1 in the invention;

FIG. 15 is curves illustrating changes of coercivity and permeability of Fe_{82.65}Si₂B₁₄Cu_{1.35} amorphous alloy ribbon after common stress-relief annealing and stress-relief annealing in magnetic field in different temperatures of the comparative example 1 in the invention.

### DETAILED DESCRIPTION OF THE PREFERRED EMBODIMENTS

The invention provides a Fe—Co based amorphous soft magnetic alloy with a chemical composition of FeₐCo_{b}Si_{c}B_{d}Cuₑ wherein a, b, c, d, and e respectively represent the atomic percentage of corresponding components; a=60˜85, b=1˜20, c=0˜4, d=12˜16, e=0.5˜1.5, a+b+c+d+e=100.

In the invention, as a preferred solution, said a+b=82˜83, c=0˜2, d=12˜14, e=1˜1.5, a+b+c+d+e=100.

In the invention, preferably, said Fe—Co based amorphous soft magnetic alloy comprises Fe_{78.65}Co₄Si₂B₁₄Cu_{1.35}, Fe_{74.65}Co₈Si₂B₁₄Cu_{1.35}, Fe_{70.65}Co₁₂Si₂B₁₄Cu_{1.35}, Fe_{66.65}Co₁₆Si₂B₁₄Cu_{1.35} and Fe_{62.65}Co₂₀Si₂B₁₄Cu_{1.35}.

The invention provides the preparation method of said Fe—Co based amorphous soft magnetic alloy in the above technical plan comprising following steps:

Mixing raw materials of Fe, Co, Si, B and Cu according to the atomic percentage to obtain a mixture;

smelting said mixture to obtain a master alloy ingot;

preparing the master alloy ingot into an amorphous alloy ribbon via single roll cold method;

annealing said amorphous alloy ribbon to obtain the Fe—Co based amorphous soft magnetic alloy.

The invention mixes raw materials of Fe, Co, Si, B and Cu according to the atomic percentage to obtain a mixture wherein said Fe, Co, Si, B and Cu raw materials preferably have a purity of >99%.

The source of the raw materials of Fe, Co, Si, B and Cu is not particularly required in the invention, and those well known to those skilled in the art can be selected, such as raw materials available in the market.

After the mixture is obtained, the mixture will be smelted to obtain a master alloy ingot. In the invention, said smelting is preferably carried out in high-frequency induction melting furnace, the melting conditions of which are not particularly limited and may be carried out under conditions known to those skilled in the art.

After obtaining the master alloy ingot, the invention adopts single roll cold method to prepare said master alloy ingot into an amorphous alloy ribbon. In the invention, the single roll cold method is preferably carried out to prepare the amorphous alloy ribbon via VF-RQB20 type melt-spun apparatus produced by Japanese Company—Makabe Giken Co., Ltd. In embodiments of the invention, preparing the amorphous alloy ribbon by the single roll cold method preferably includes following steps: adjusting the size of tube orifice of a quartz tube to be 0.8˜1 mm by using sand paper; crushing the master alloy ingot, loading the crushed master alloy ingot into the quartz tube and fixing it in an induction coil; adjusting the upper position and the lower position of the quartz tube to control the distance between the tube orifice and roll surface to be about 0.25 mm; firstly evacuating to be below 5 Pa, secondly evacuating to 8×10⁻³ Pa, then filling protective gas (high-purity argon) into the quartz tube; controlling pressure difference (0.015˜0.020 MPa) between the cavity of the melt-spun machine and the quartz tube, setting the surface linear velocity of a copper roll, switching on heating current, heating and melting the master alloy to injection temperature by using the solenoid, and pressing the injection button to inject to obtain amorphous alloy ribbon. In the invention, the injection pressure of the single roll cold method is preferably at 0.01˜0.03 MPa, and more preferably at 0.015˜0.02 MPa; the injection temperature of said single roll cold method is preferably at 1000˜1050° C., and more preferably at 1020˜1040° C.; the surface linear velocity of the copper roll is preferably at 30˜50 m/s, and more preferably at 35˜45 m/s. In the invention, the bandwidth of the amorphous alloy ribbon is preferably 1˜1.5 mm, and the thickness thereof is preferably 20˜30 μm.

After obtaining amorphous alloy ribbon, the invention anneals said amorphous alloy ribbon to obtain the Fe—Co based amorphous soft magnetic alloy. The annealing process is preferably carried out in a vacuum atmosphere or an inert atmosphere, and the vacuum degree of the vacuum atmosphere is (5˜8)×10⁻³ Pa, more preferably (6˜7)×10⁻³ Pa. In the invention, said annealing process is carried out preferably under the action of external magnetic field; the magnetic field strength of said external magnetic field is 200-1500 Oe, more preferably 500˜1200 Oe and most preferably 1000 Oe. In the invention, said annealing temperature is preferably 290-370° C., and more preferably 350˜370° C.; said annealing time is 5-30 min, more preferably 10˜20 min and most preferably 15 min.

In embodiments of the invention, said annealing process includes following steps: Cutting the amorphous alloy ribbon into a 60-mm-long ribbon, placing the ribbon into the quartz tube matched with a tubular magnetic field annealing furnace; firstly evacuating to be below 5 Pa, secondly evacuating to (5˜8)×10⁻³ Pa; when the temperature of the tubular furnace rises to 290˜370° C., pushing the quartz tube into the tubular furnace, simultaneously applying external magnetic field whose direction is parallel with that of ribbon, preserving heat, quenching the obtained product and cooling to room temperature to obtain the Fe—Co based amorphous ribbon, namely the Fe—Co based amorphous soft magnetic alloy.

The Fe—Co based amorphous soft magnetic alloy and preparation method thereof is further described in detail hereinafter with reference to the embodiments, but the protective scope of the invention is not limited thereto.

### Embodiment 1

Mixing raw materials of Fe, Co, Si, B and Cu whose purity exceed 99% according to the atomic percentage (molecular formula: Fe_{66.65}Co₁₆Si₂B₁₄Cu_{1.35}) to obtain a mixture;

placing said mixture into crucible of the induction melting furnace and smelting to obtain a master alloy ingot;

the single roll cold method is adopted to prepare the amorphous alloy ribbon via VF-RQB20 type melt-spun apparatus produced by Japanese Company—Makabe Giken Co., Ltd. Specifically, adjusting the sized of the tube orifice of a quartz tube to 0.8 mm by using sand paper; crushing said master alloy ingot, loading the crushed master alloy ingot into the quartz tube and fixing it in an induction coil; adjusting the upper position and the lower position of the quartz tube to control the distance between the tube orifice and roll surface to be about 0.25 mm; firstly evacuating to be below 5 Pa, secondly evacuating to 8×10⁻³ Pa, then filling protective gas (high-purity argon) into the quartz tube; the pressure difference is 0.015 MPa; setting the surface linear velocity of a copper roll at about 45 m/s, switching on heating current, heating and melting the master alloy to 1050° C. by using the solenoid, then pressing the injection button, rapidly injecting melting alloy liquid onto the surface of a copper roll which is rotating at a high speed by utilizing the air pressure difference between internal quartz tube and the cavity, rapidly cooling to obtain the amorphous alloy ribbon with the width of 1.3 mm and the thickness of 30 μm;

cutting said amorphous alloy ribbon into a 60-mm-long ribbon, placing the ribbon into the quartz tube matched with a tubular magnetic field annealing furnace; firstly evacuating to be below 5 Pa, secondly evacuating to 5×10⁻³ Pa; when the temperature of the tubular furnace rises to 290˜370° C., pushing the quartz tube into the tubular furnace, simultaneously applying 1000 Oe external magnetic field whose direction is parallel with that of ribbon, preserving temperature for 15 min, quenching the obtained product and cooling to room temperature to obtain the Fe—Co based amorphous ribbon after stress-relief annealing in magnetic field, namely the Fe—Co based amorphous soft magnetic alloy.

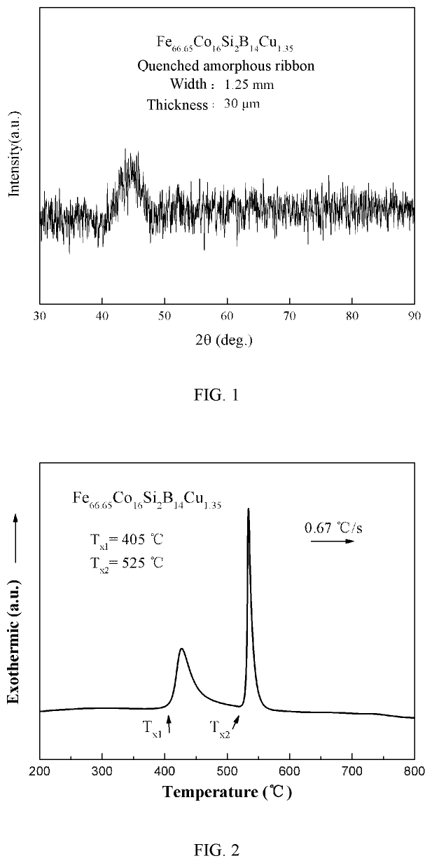

FIG. 1 is the XRD diffraction diagram illustrating the prepared amorphous alloy ribbon of the embodiment 1 which only has one dispersing diffraction peak indicating that the ribbon obtained is amorphous;

FIG. 2 is the DSC curve illustrating the amorphous alloy ribbon of the embodiment 1 wherein the heating rate is 40 K/min, the first initial crystallization temperature (T_{×1}) 405° C. and second initial crystallization temperature (T_{×2}) 525° C.;

FIG. 3 is the XRD diffraction diagram illustrating the amorphous alloy ribbon of the embodiment 1, in a high-vacuum environment, after annealing in 370° C. for 15 min which still has one dispersing diffraction peak indicating that the ribbon obtained after annealing in 370° C. is still amorphous;

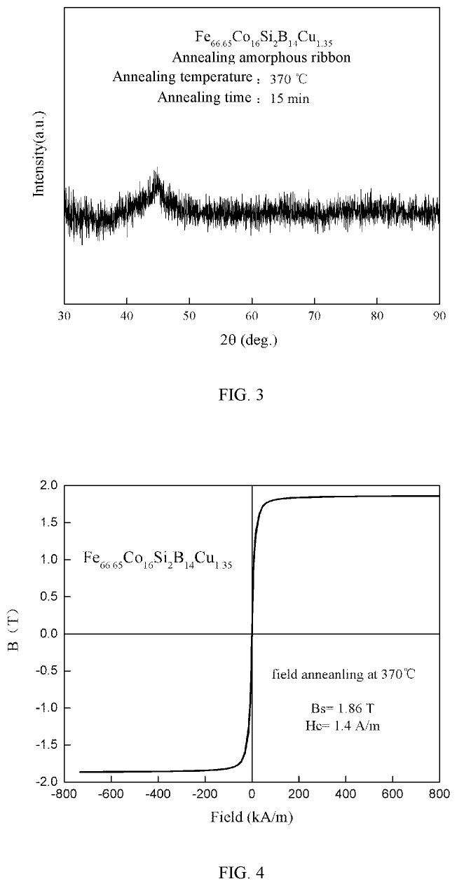

FIG. 4 is the hysteresis loop illustrating the amorphous alloy ribbon after magnetic field annealing in 370° C. for 15 min which shows that the saturation magnetic induction of the amorphous alloy ribbon can reach 1.86 T.

Besides, cutting said amorphous alloy ribbon into a 60-mm-long ribbon, placing the ribbon into the quartz tube matched with a tubular magnetic field annealing furnace; firstly evacuating to be below 5 Pa, secondly evacuating to 5×10⁻³ Pa; when the temperature of the tubular furnace rises to 290˜370° C., pushing the quartz tube into the tubular furnace, preserving temperature for 15 min, quenching the obtained product and cooling to room temperature to obtain the Fe—Co based amorphous ribbon after going through common stress-relief annealing process.

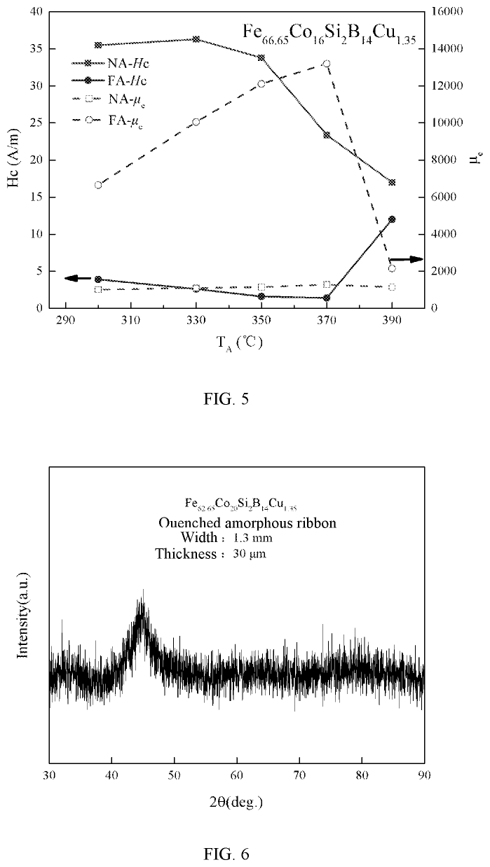

FIG. 5 is curves illustrating changes of coercivity and permeability of amorphous alloy ribbon after common stress-relief annealing and stress-relief annealing in magnetic field in different temperatures wherein the coercivity of the common stress-relief annealing is 23.4 A/m at the lowest, and the permeability is 1280 at the highest; the coercivity of the stress-relief annealing in magnetic field is 1.4 A/m at the lowest, and the magnetic permeability is 13200 at the highest, indicating that the soft magnetic performance after going through stress-relief annealing in magnetic field is greatly improved; in addition, it can be seen from the diagram that the sample crystallized and the performance deteriorated when annealed at 390° C.

### Embodiment 2

Mixing raw materials of Fe, Co, Si, B and Cu whose purity exceed 99% according to the atomic percentage (molecular formula: Fe_{62.65}Co₂₀Si₂B₁₄Cu_{1.35}) to obtain a mixture;

placing said mixture into crucible of the induction melting furnace and smelting to obtain a master alloy ingot;

the single roll cold method is adopted to prepare the amorphous alloy ribbon via VF-RQB20 type melt-spun apparatus produced by Japanese Company—Makabe Giken Co., Ltd. Specifically, adjusting the sized of the tube orifice of a quartz tube to 1 mm by using sand paper; crushing said master alloy ingot, loading the crushed master alloy ingot into the quartz tube and fixing it in an induction coil; adjusting the upper position and the lower position of the quartz tube to control the distance between the tube orifice and roll surface to be about 0.25 mm; firstly evacuating to be below 5 Pa, secondly evacuating to 8×10⁻³ Pa, then filling protective gas (high-purity argon) into the quartz tube; the pressure difference is 0.015 MPa; setting the surface linear velocity of a copper roll at about 45 m/s, switching on heating current, heating and melting the master alloy to 1050° C. by using the solenoid, then pressing the injection button, rapidly injecting melting alloy liquid onto the surface of a copper roll which is rotating at a high speed by utilizing the air pressure difference between internal quartz tube and the cavity, rapidly cooling to obtain the amorphous alloy ribbon with the width of 1.3 mm and the thickness of 30 μm;

cutting said amorphous alloy ribbon into a 60-mm-long ribbon, placing the ribbon into the quartz tube matched with a tubular magnetic field annealing furnace; firstly evacuating to be below 5 Pa, secondly evacuating to 5×10⁻³ Pa; when the temperature of the tubular furnace rises to 290˜370° C., pushing the quartz tube into the tubular furnace, simultaneously applying 1000 Oe external magnetic field whose direction is parallel with that of ribbon, preserving temperature for 15 min, quenching the obtained product and cooling to room temperature to obtain the Fe—Co based amorphous ribbon after stress-relief annealing in magnetic field, namely the Fe—Co based amorphous soft magnetic alloy.

FIG. 6 is the XRD diffraction diagram illustrating the prepared amorphous alloy ribbon of the embodiment 2 which only has one dispersing diffraction peak indicating that the ribbon obtained is amorphous;

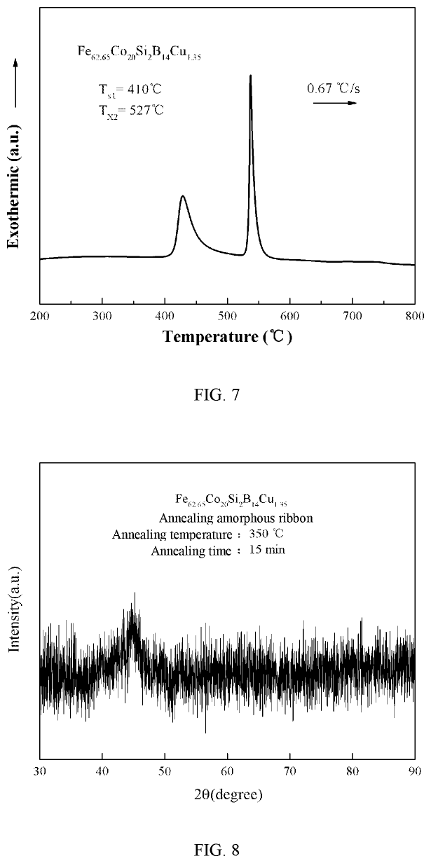

FIG. 7 is the DSC curve illustrating the amorphous alloy ribbon of the embodiment 2 wherein the heating rate is 40 K/min, the first initial crystallization temperature (T_{×1}) 410° C. and second initial crystallization temperature(T_{×2}) 527° C.;

FIG. 8 is the XRD diffraction diagram illustrating the amorphous alloy ribbon of the embodiment 2, in a high-vacuum environment, after annealing in 370° C. for 15 min which still has one dispersing diffraction peak indicating that the ribbon obtained after annealing in 370° C. is still amorphous;

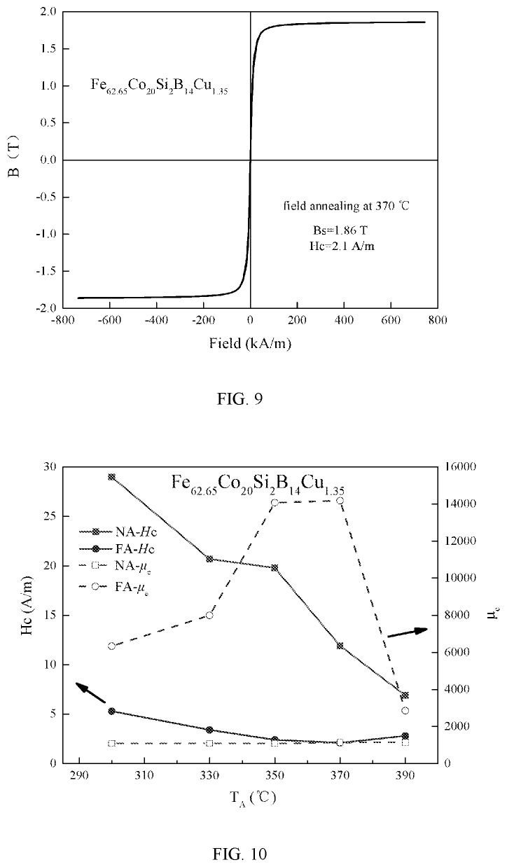

FIG. 9 is the hysteresis loop illustrating the amorphous alloy ribbon after magnetic field annealing in 370° C. for 15 min which shows that the saturation magnetic induction of the amorphous alloy ribbon can reach 1.86 T.

Besides, cutting said amorphous alloy ribbon into a 60-mm-long ribbon, placing the ribbon into the quartz tube matched with a tubular magnetic field annealing furnace; firstly evacuating to be below 5 Pa, secondly evacuating to 5×10⁻³ Pa; when the temperature of the tubular furnace rises to 290˜370° C., pushing the quartz tube into the tubular furnace, preserving temperature for 15 min, quenching the obtained product and cooling to room temperature to obtain the Fe—Co based amorphous ribbon after going through common stress-relief annealing process.

FIG. 10 is curves illustrating changes of coercivity and permeability of amorphous alloy ribbon after common stress-relief annealing and stress-relief annealing in magnetic field in different temperatures wherein the coercivity of the common stress-relief annealing is 11.9 A/m at the lowest, and the permeability is 1138 at the highest; the coercivity of the stress-relief annealing in magnetic field is 2.1 A/m at the lowest, and the magnetic permeability is 14187 at the highest, indicating that the soft magnetic performance after going through stress-relief annealing in magnetic field is greatly improved; in addition, it can be seen from the diagram that the sample crystallized and the performance deteriorated when annealed at 390° C.

### COMPARATIVE EXAMPLE 1

Mixing raw materials of Fe, Co, Si, B and Cu whose purity exceed 99% according to the atomic percentage (molecular formula: Fe_{82.65}Si₂B₁₄Cu_{1.35}) to obtain a mixture;

placing said mixture into crucible of the induction melting furnace and smelting to obtain a master alloy ingot;

the single roll cold method is adopted to prepare the amorphous alloy ribbon via VF-RQB20 type melt-spun apparatus produced by Japanese Company—Makabe Giken Co., Ltd. Specifically, adjusting the sized of the tube orifice of a quartz tube to 0.8 mm by using sand paper; crushing said master alloy ingot, loading the crushed master alloy ingot into the quartz tube and fixing it in an induction coil; adjusting the upper position and the lower position of the quartz tube to control the distance between the tube orifice and roll surface to be about 0.25 mm; firstly evacuating to be below 5 Pa, secondly evacuating to 8×10⁻³ Pa, then filling protective gas (high-purity argon) into the quartz tube; the pressure difference is 0.015 MPa; setting the surface linear velocity of a copper roll at about 45 m/s, switching on heating current, heating and melting the master alloy to 1050° C. by using the solenoid, then pressing the injection button, rapidly injecting melting alloy liquid onto the surface of a copper roll which is rotating at a high speed by utilizing the air pressure difference between internal quartz tube and the cavity, rapidly cooling to obtain the amorphous alloy ribbon with the width of 1 mm and the thickness of 20 μm;

cutting said amorphous alloy ribbon into a 60-mm-long ribbon, placing the ribbon into the quartz tube matched with a tubular magnetic field annealing furnace; firstly evacuating to be below 5 Pa, secondly evacuating to 5×10⁻³ Pa; when the temperature of the tubular furnace rises to 270˜350° C., pushing the quartz tube into the tubular furnace, simultaneously applying 1000 Oe external magnetic field whose direction is parallel with that of ribbon, preserving temperature for 15 min, quenching the obtained product and cooling to room temperature to obtain the Fe—Co based amorphous ribbon after stress-relief annealing in magnetic field.

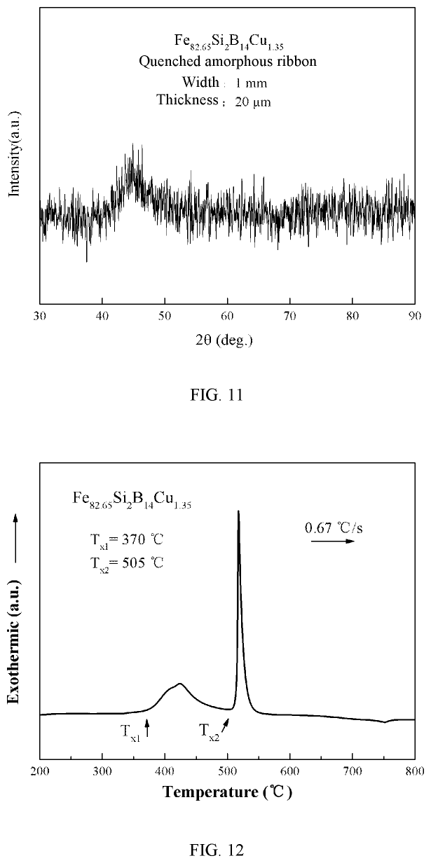

FIG. 11 is the XRD diffraction diagram illustrating the prepared amorphous alloy ribbon of the comparative example 1 which only has one dispersing diffraction peak indicating that the ribbon obtained is amorphous;

FIG. 12 is the DSC curve illustrating the amorphous alloy ribbon of the comparative example 1 wherein the heating rate is 40 K/min, the first initial crystallization temperature (T_{×1}) 370° C. and second initial crystallization temperature(T_{×2}) 505° C.;

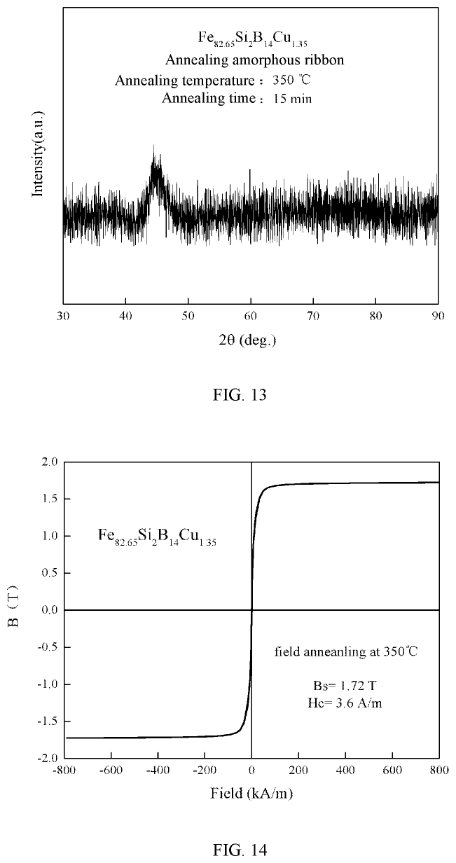

FIG. 13 is the XRD diffraction diagram illustrating the amorphous alloy ribbon of the comparative example 1, in a high-vacuum environment, after annealing in 350° C. for 15 min which still has one dispersing diffraction peak indicating that the ribbon obtained after annealing in 350° C. is still amorphous;

FIG. 14 is the hysteresis loop illustrating the amorphous alloy ribbon after magnetic field annealing in 350° C. for 15 min which shows that the saturation magnetic induction of the amorphous alloy ribbon can reach 1.72 T.

Besides, cutting said amorphous alloy ribbon into a 60-mm-long ribbon, placing the ribbon into the quartz tube matched with a tubular magnetic field annealing furnace; firstly evacuating to be below 5 Pa, secondly evacuating to 5×10⁻³ Pa; when the temperature of the tubular furnace rises to 270˜350° C., pushing the quartz tube into the tubular furnace, preserving temperature for 15 min, quenching the obtained product and cooling to room temperature to obtain the Fe—Co based amorphous ribbon after going through common stress-relief annealing process.

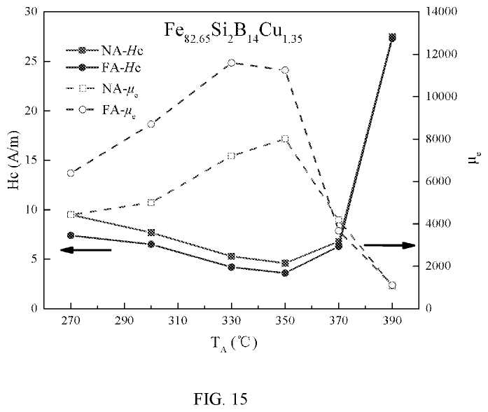

FIG. 15 is curves illustrating changes of coercivity and permeability of amorphous alloy ribbon after common stress-relief annealing and stress-relief annealing in magnetic field in different temperatures wherein the coercivity of the common stress-relief annealing is 4.6 A/m at the lowest, and the permeability is 8011 at the highest; the coercivity of the stress-relief annealing in magnetic field is 3.6 A/m at the lowest, and the magnetic permeability is 11600 at the highest, indicating that the soft magnetic performance after going through stress-relief annealing in magnetic field is slightly improved compared with that after going through common stress-relief annealing.

According to the embodiments 1-2 and the comparative example 1, the invention obtains amorphous soft magnetic alloy with highly-saturated magnetic induction, outstanding soft magnetic property and great amorphous forming ability by adding Co element into the Fe-based amorphous alloy and combining annealing in the magnetic field; compared with current Fe-based amorphous magnetic alloy, in the Fe—Co based amorphous soft magnetic alloy prepared in the invention, its saturation magnetic induction can reach 1.86 T, coercivity can reach 4.3 A/m, and permeability can be up to 14000, improved the performance of the Fe-based amorphous magnetic alloy remarkably.

As can be seen from above embodiments, the invention provides a Fe—Co based amorphous soft magnetic alloy which possesses merits of highly-saturated magnetic induction, outstanding soft magnetic property and great amorphous forming ability at the same time; the embodiment of Fe—Co based amorphous soft magnetic alloy disclosed in the invention has indicated that its saturation magnetic induction is 1.79˜1.86 T, coercivity 1.4˜4.3 A/m, and permeability 8000˜14000; the invention has advantages of easy treatment process, low annealing temperature, which reduces process cost remarkably and economizes energy, thus having great application prospect.

The invention and its embodiment have been described above, but the description is not limited thereto; In general, it is to be understood by those skilled in the art that equivalent structures or equivalent process transformations or use in other related technical fields directly or indirectly by taking advantage of the description of the specification and drawings in the invention shall all fall within the protective scope of the invention.

1. A Fe—Co based amorphous soft magnetic alloy with a chemical composition of FeₐCo_{b}Si_{c}B_{d}Cuₑ wherein a, b, c, d, and e respectively represent the atomic percentage of corresponding components; a=60˜85, b=1˜20, d=12˜16, e=0.5˜1.5, a+b+c+d+e=100.

2. The Fe—Co based amorphous soft magnetic alloy of claim 1, wherein a+b=82˜83, c=0˜2, d=12˜14, a+b+c+d+e=100.

3. The Fe—Co based amorphous soft magnetic alloy of claim 1, wherein said Fe—Co based amorphous soft magnetic alloy comprises Fe_{78.65}Co₄Si₂B₁₄Cu_{1.35,} Fe_{74.65}Co₈Si₂B₁₄Cu_{1.35}, Fe_{70.65}Co₁₂Si₂B₁₄Cu_{1.35}, Fe_{66.65}Co₁₆Si₂B₁₄Cu_{1.35} and Fe_{62.65}Co₂₀Si₂B₁₄Cu_{1.35}.

4. The method for the preparation of the Fe—Co based amorphous soft magnetic alloy defined by claim 1, wherein it comprising following steps:
Mixing raw materials of Fe, Co, Si, B and Cu according to the atomic percentage to obtain a mixture;
smelting said mixture to obtain a master alloy ingot;
preparing the master alloy ingot into an amorphous alloy ribbon via single roll cold method;
annealing said amorphous alloy ribbon to obtain the Fe—Co based amorphous soft magnetic alloy.

5. The preparation method of claim 4 wherein said Fe, Co, Si, B and Cu raw materials have a purity of >99%.

6. The preparation method of claim 4 wherein the injection pressure of said single roll cold method is 0.01-0.03 MPa, the injection temperature is 1000-1050° C., and the linear velocity of the surface of the copper roll is 30˜50 m/s.

7. Tho preparation method of claim 4 wherein the width of said amorphous alloy ribbon is 1-1.5 mm, and the thickness thereof is 20-30 μm.

8. The preparation method of claim 4 wherein said annealing treatment is carried out in a vacuum atmosphere or an inert atmosphere, and the vacuum degree of the vacuum atmosphere is (5˜8)×10⁻³ Pa.

9. The preparation method of claim 4 wherein said annealing process is carried out under the action of an external magnetic field; the magnetic field strength of said external magnetic field is 200-1500 Oe.

10. The preparation method of claim 4 wherein said annealing temperature is 290-370 and the annealing time is 5-30 min.
